(19) United States
(12) Patent Application Publication
(10) Pub. No.: US 2019/0118570 A1
(43) Pub. Date: Apr. 25, 2019

(54) ROLL-SHAPED PAPER AND PRINTER

(71) Applicant: TOSHIBA TEC KABUSHIKI KAISHA, Tokyo (JP)

(72) Inventor: Suguru KATO, Sunto Shizuoka (JP)

(21) Appl. No.: 16/156,381

(22) Filed: Oct. 10, 2018

(30) Foreign Application Priority Data
Oct. 25, 2017 (JP) 2017-206214

(51) Int. Cl. B41M 7/00; B41J 11/00

(52) U.S. Cl. CPC B41M 7/009; B41J 11/002

(57) ABSTRACT

A paper roll, in which a paper strip is wound in the form of a roll, includes a marker formed of a medium containing a phosphorescent material on an end portion of the paper strip that extends from a finishing end of the paper roll to a position that is a predetermined length from the finishing end. A printer includes a roller configured to convey paper supplied from the paper roll, a printing head configured to print information on the paper conveyed by the roller, one or more ultraviolet light emitting diodes (LEDs) positioned downstream of the printing head in a conveyance direction of the paper, and a control unit configured to turn on the LEDs to irradiate the paper on which the information has been printed and discharged out of the printer.

### CROSS-REFERENCE TO RELATED APPLICATION

This application is based upon and claims the benefit of priority from Japanese Patent Application No. 2017-206214, filed on Oct. 25, 2017, the entire contents of which are incorporated herein by reference.

### FIELD

Embodiments described herein relate roll-shaped paper and a printer.

### BACKGROUND

In the related arts, roll-shaped paper which is used, for example, for receipt printing in a POS terminal, is known. With such roll-shaped paper, it is desirable to notify an operator before the end of the roll-shaped paper, that the remaining amount of the paper is low. For this reason, an example is known in which a marker indicating a low remaining amount of paper is printed on the roll-shaped paper.

In such roll-shaped paper having the marker, however, since the customer who receives the receipt sees the marker unrelated to information printed on the receipt, that is, commodity information of the purchased commodity, the paper will not be as clean looking because of the marker.

### DESCRIPTION OF THE DRAWINGS

FIG. 1 is an external view illustrating an example of a payment apparatus according to a first embodiment;

FIG. 2 is a hardware block diagram illustrating an example of a hardware configuration of the payment apparatus;

FIG. 3 is a perspective view illustrating a state where an upper case of a receipt printer is opened;

FIG. 4 is a sectional view illustrating an example of an internal structure of the receipt printer;

FIG. 5 is a hardware block diagram illustrating an example of a hardware configuration of the receipt printer;

FIG. 6 is a functional block diagram illustrating an example of a functional configuration of the receipt printer;

FIG. 7 is a diagram illustrating an example of a structure of roll paper including a remaining amount marker;

FIGS. 8A and 8B are diagrams illustrating other examples of the remaining amount marker;

FIG. 9 is a flowchart illustrating an example of a processing flow when the receipt printer prints and issues a receipt;

FIG. 10 is a flowchart illustrating an example of a flow of lighting control of an ultraviolet LED;

FIG. 11 is a diagram illustrating an example of a remaining amount marker indicating the remaining amount of roll paper;

FIG. 12 is a hardware block diagram illustrating an example of a hardware configuration of a receipt printer according to a second embodiment;

FIG. 13 is a functional block diagram illustrating an example of a functional configuration of the receipt printer according to the second embodiment;

FIGS. 14A and 14B are first set of diagrams illustrating a method of detecting a remaining amount marker with the receipt printer in the second embodiment, and illustrate a state where the remaining amount marker is not detected;

FIGS. 15A and 15B are a second set of diagrams illustrating a method of detecting the remaining amount marker with the receipt printer in the second embodiment, and illustrate a state where the remaining amount marker is detected; and

FIG. 16 is a flowchart illustrating an example of a processing flow when the receipt printer of the second embodiment prints and issues a receipt.

### DETAILED DESCRIPTION

Embodiments provide a roll-shaped paper and a printer capable of notifying an operator, who prints a receipt, that the remaining amount of the roll-shaped paper is low without hindering visibility of printed information.

In general, according to one embodiment, a paper roll, in which a paper strip is wound in the form of a roll, includes a marker formed of a medium containing a phosphorescent material on an end portion of the paper strip that extends from a finishing end of the paper roll to a position that is a predetermined length from the finishing end.

Further, according to the other embodiment, a printer includes a roller configured to convey paper supplied from a paper roll, a printing head configured to print information on the paper conveyed by the roller, one or more ultraviolet light emitting diodes (LEDs) positioned downstream of the printing head in a conveyance direction of the paper, and a control unit configured to turn on the LEDs to irradiate the paper on which the information has been printed and discharged out of the printer.

### First Embodiment

A payment apparatus for registration and payment of commodities purchased by customers is an example of one embodiment.

### Schematic Configuration of Payment Apparatus

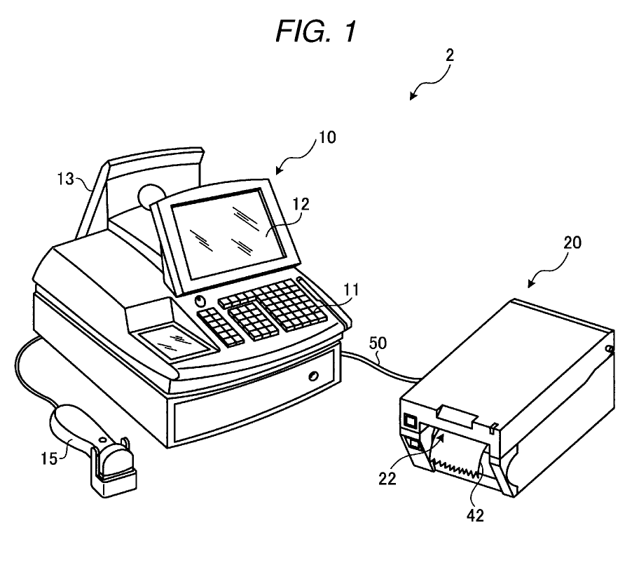

First, a schematic configuration of a payment apparatus will be described with reference to FIG. 1. FIG. 1 is an external view illustrating an example of a payment apparatus 2. As illustrated in FIG. 1, the payment apparatus 2 includes a POS terminal 10 and a receipt printer 20.

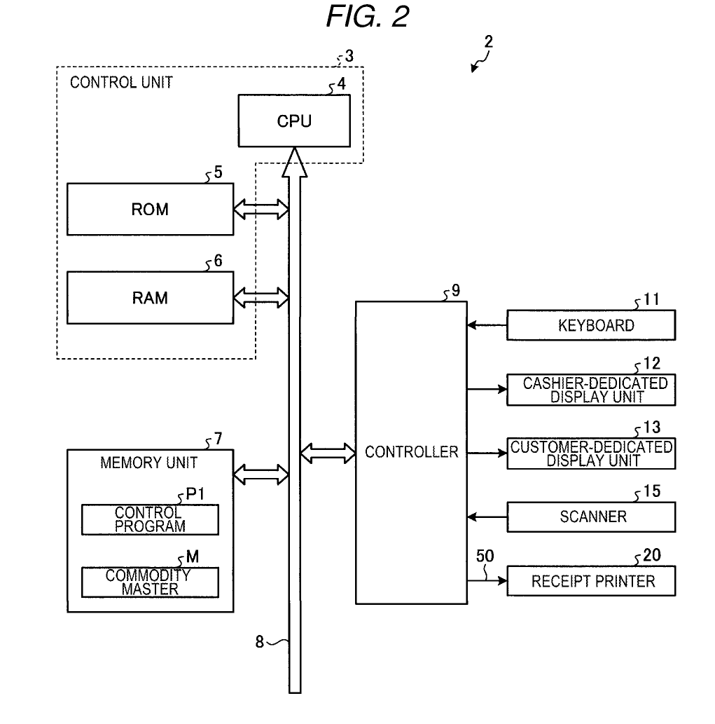

The POS terminal 10 is a terminal that registers commodity information (e.g., commodity code, quantity, price, and the like) of a commodity purchased by a customer. As illustrated in FIG. 1, the POS terminal 10 includes a keyboard 11, a display unit 12 for a cashier and a display unit 13 for the customer, both of which are liquid crystal displays, and a scanner 15. The keyboard 11 includes, for example, ten keys, section keys, a subtotal key, a deposit/current total key, a receipt issue key, a settlement key, a tax free key, and item list output key. The display unit 12 and the display unit 13 may include a touch panel function to input simple information with a touch operation. The scanner 15 reads commodity information included in a barcode attached to the commodity purchased by the customer, and transmits the read information to a CPU (Central Processing Unit) 4 (see FIG. 2).

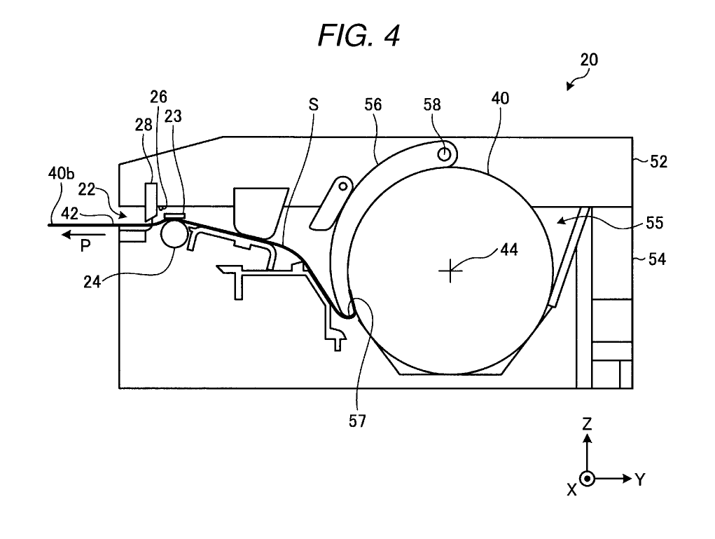

The receipt printer 20 is connected to the POS terminal 10 via a USB (Universal Serial Bus) cable 50, for example. The receipt printer 20 receives sales information transmitted from the POS terminal 10, and prints the sales information on a paper roll 40 (see FIG. 4). In addition, the receipt printer 20 prints the sales information on the paper roll 40 and discharges the paper on which the sales information is printed and which is cut off from the paper roll 40, as a receipt 42, from a receipt issuing port 22. The receipt printer 20 is an example of a printer. Further, the paper roll 40 is an example of roll-shaped paper. The sales information is information including commodity information that is registered by the POS terminal 10. In the embodiment, the receipt printer 20 and the POS terminal 10 are described as separate units, but the POS terminal 10 and the receipt printer 20 may be configured to be integrated as a single unit.

The customer moves to a payment apparatus 2 with the commodities to be purchased in a basket. Then, the cashier, who is an operator of the POS terminal 10 in the payment apparatus 2, picks the commodities out from the basket and registers commodity information of each commodity. Specifically, the cashier performs reading of code information, which is registered in a code symbol such as a bar code attached to the commodity, with the scanner 15. Then, the POS terminal 10 collates the read code information with a commodity master file M (see FIG. 2), and specifies the commodity information to be purchased by the customer based on the commodity master file M. Subsequently, the POS terminal 10 performs commodity registration and settlement based on the read commodity information.

Hardware configuration of Payment Apparatus

A hardware configuration of the payment apparatus 2 will be described below with reference to FIG. 2. FIG. 2 is a hardware block diagram illustrating an example of the hardware configuration of the payment apparatus 2.

As illustrated in FIG. 2, the payment apparatus 2 includes a control unit 3 and a memory unit 7. The control unit 3 is a computer that controls the overall operation of the payment apparatus 2 and realizes various functions of the payment apparatus 2. The control unit 3 includes a CPU (Central Processing Unit) 4, a ROM (Read Only Memory) 5, and a RAM (Random Access Memory) 6. The CPU 4 controls the operation of the payment apparatus 2. The ROM 5 is a storage medium that stores various programs and data. The RAM 6 is a storage medium that temporarily stores various programs and rewrites various data. Then, the CPU 4 executes a control program P1 stored in the memory unit 7 or the like with the RAM 6 as a work area to realize various functions of the payment apparatus 2. That is, the control unit 3 has a general computer configuration.

The memory unit 7 is a storage device such as an HDD (Hard Disk Drive) or an SSD (Solid State Drive). The memory unit 7 is connected to the control unit 3 via an internal bus 8. The memory unit 7 stores the control program P1 and the commodity master file M, for example. The control program P1 is a program to implement the operating system or the functions of the POS terminal 10. The control program P1 includes a program for realizing a characteristic function according to the embodiment. Further, the memory unit 7 stores the commodity master file M provided from a store server (not illustrated) for managing the POS terminal 10. The commodity master file M is a master file that associates a commodity code capable of identifying the commodity, a commodity name, and a unit price of commodity price with each other for each commodity sold at the store.

The control unit 3 is connected to a controller 9 via the internal bus 8. Then, the controller 9 is connected to each of the keyboard 11, the display unit 12, the display unit 13, and the scanner 15. Further, the controller 9 is connected to the receipt printer 20 via the USB cable 50.

### Internal Structure of Receipt Printer

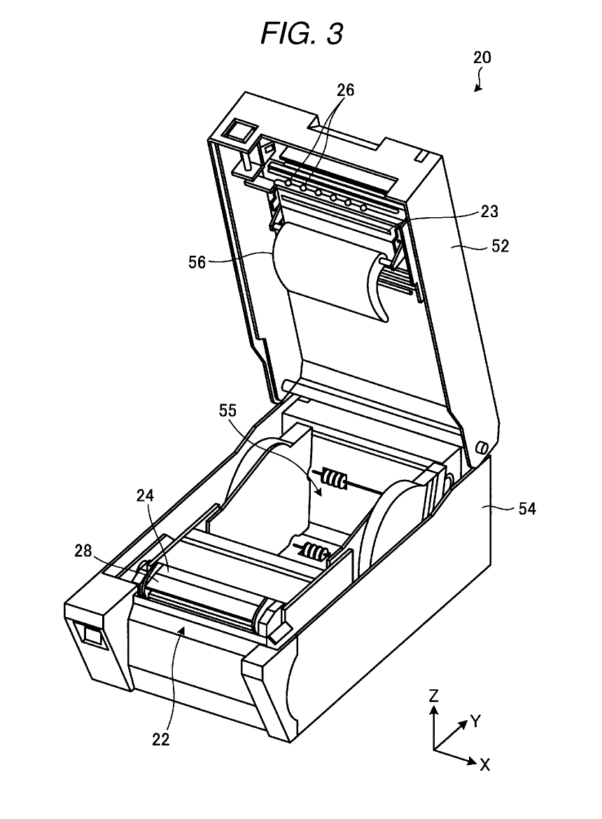

An internal structure of the receipt printer 20 will be described below with reference to FIGS. 3 and 4. FIG. 3 is a perspective view illustrating a state where an upper case 52 of the receipt printer 20 is opened. In addition, FIG. 4 is a sectional view (Y-Z sectional view) illustrating an example of the internal structure of the receipt printer 20. As illustrated in FIG. 3, the receipt printer 20 includes a thermal head 23, a platen roller 24, an ultraviolet LED (Light Emitting Diode) 26, a cutter 28, an accommodating portion 55, and a bumper 56 therein. A function of each portion will be described below. For the following description, as illustrated in FIG. 3, an XYZ coordinate system is set with a horizontal direction of the receipt printer 20 as an X axis, a depth direction as a Y axis, and a vertical direction as a Z axis.

The accommodating portion 55 accommodates the paper roll 40 (see FIG. 4). The paper roll 40 is thermal paper wound in a roll shape. When printing on the paper roll 40, as illustrated in FIG. 4, a leading end 40b of the paper roll 40 is pulled by rotation of the platen roller 24, whereby the outermost portion of the paper roll 40 is pulled out from the roll.

When accommodating the paper roll 40, as illustrated in FIG. 3, the receipt printer 20 of the embodiment adopts a so-called drop-in system in which the upper case 52 is opened and the paper roll 40 is fed into the accommodating portion 55. A lower case 54 is a rectangular parallelepiped case whose top is opened, and the top of the lower case 54 is closed by the upper case 52. The lower case 54 is provided with a connection terminal (not illustrated) used for connection between the receipt printer 20 and the POS terminal 10 (see FIG. 1) and a power supply terminal (not illustrated) for supplying power to the receipt printer 20. The receipt printer 20 is not limited to the drop-in system, but may be a system in which the paper roll 40 is loaded as a set in a paper holder.

The back side of the upper case 52 (a positive side of the Y axis) is rotatably attached to the lower case 54, and the top side of the lower case 54 is opened and closed with the rotation of the upper case 52. Between a lower part of a front end (a negative side of the Y axis) of the upper case 52 and an upper part of a front end (a negative side of the Y axis) of the lower case 54, the receipt issuing port 22 is provided to discharge the printed paper roll 40 as a receipt 42 (see FIG. 4). The receipt issuing port 22 is an example of a paper discharge unit.

In FIG. 4, the paper roll 40 is guided by a leading end 57 of the bumper 56 and is pulled out in a direction indicated by the conveyance direction P from the leading end 40b by rotation of the platen roller 24. The leading end 57 of the bumper 56 has a curved surface shape in the Y-axis direction. Therefore, the conveyance direction of the paper roll 40 is gradually changed at the leading end 57 of the bumper 56. By this structure, the paper roll 40 can be smoothly pulled out and conveyed without being wrinkled or scratched.

In FIG. 4, a tail end side of the bumper 56 is pivotally supported by a shaft 58 along the X axis, and is installed so as to be rotatable around the X axis. The surface of the bumper 56 is in substantially close contact with an outer peripheral surface of the paper roll 40. Then, the bumper 56 is urged (e.g., biased by a spring) in a direction opposite to the direction in which the paper roll 40 is pulled out and conveyed (the negative side of the Y axis), that is, in a direction toward a winding center 44 of the paper roll 40 (the positive direction of the Y axis). By this structure, the roll-shaped paper roll 40 does not rattle inside the accommodating portion 55 when the paper roll 40 is pulled out.

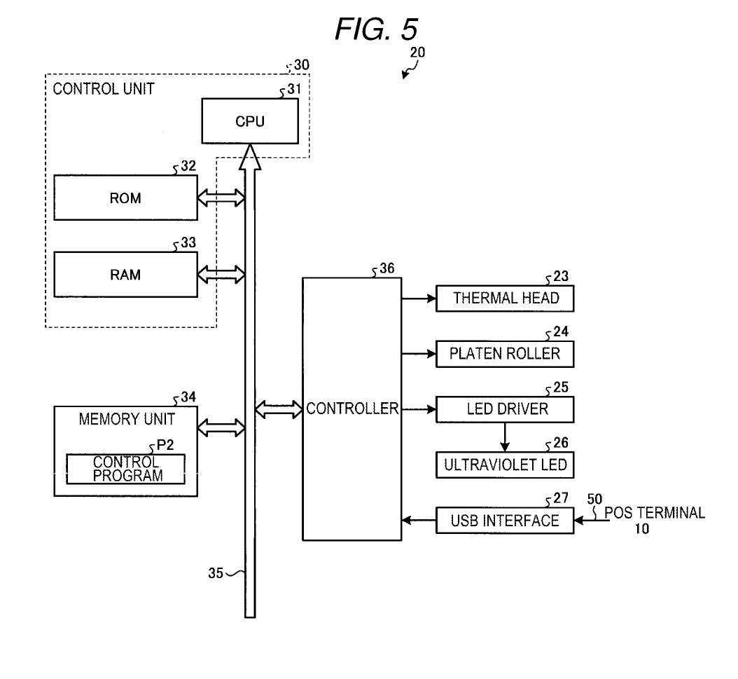

The thermal head 23 is an example of a printing unit, and is fixed to the inside of the upper case 52. The thermal head 23 is brought into close contact with the outer peripheral surface of the platen roller, which is provided in the lower case 54 and is an example of a conveyance unit, in a state where the upper case 52 is closed. Then, the thermal head 23 applies heat corresponding to the print information to a portion of the paper roll 40 passing between the thermal head 23 and the platen roller 24, whereby the paper roll 40 is printed. The print information is received from the POS terminal 10 by the receipt printer 20 via a USB interface 27 (see FIG. 5), for example.

The platen roller 24 rotates with a driving force transmitted from a stepping motor (not illustrated), and conveys the paper roll 40, which is held between the platen roller 24 and the thermal head 23, from the accommodating portion 55 on the upstream side toward the receipt issuing port 22 on the downstream side in the conveyance direction P.

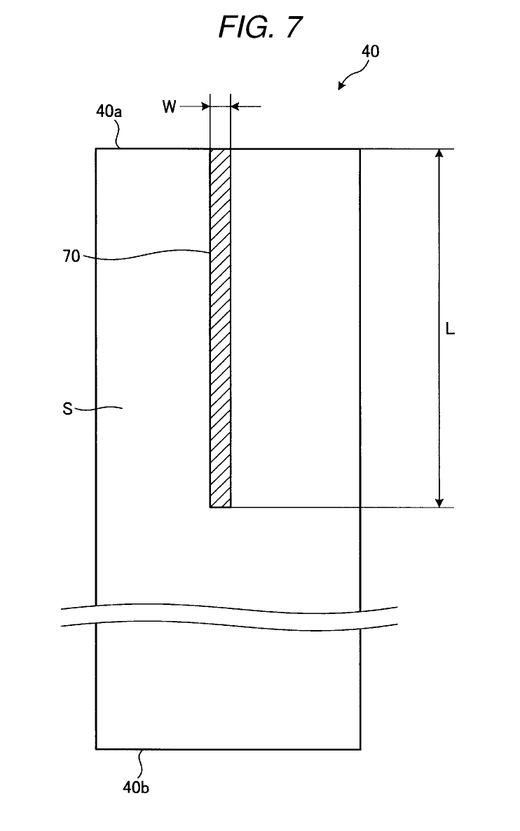

A plurality of ultraviolet LEDs 26 are arranged along the X axis on the downstream side of the thermal head 23. The ultraviolet LED 26 is an example of a light irradiation unit. The ultraviolet LED 26 irradiates a surface S, which is the surface of the receipt 42 on which a remaining amount marker (see FIG. 7) is formed, with light having a wavelength including ultraviolet rays. The surface S is the surface of the receipt 42 discharged from the receipt issuing port 22, which faces the cashier. In the embodiment, the printing surface to which the thermal head 23 abuts is the same as the surface S. The number and positions of ultraviolet LEDs 26 to be installed are determined so that the light irradiated from the ultraviolet LEDs 26 hits a remaining amount marker 70 (to be described below) without missing.

The cutter 28 cuts off the printed paper roll 40. The cut paper roll 40 is discharged as the receipt 42 from the receipt issuing port 22.

On the surface S of the paper roll 40, the remaining amount marker 70 (see FIG. 7) is formed to indicate that the remaining amount of the paper roll 40 is equal to or lower than a predetermined amount. The remaining amount marker 70 is formed, for example, by applying ink containing a phosphorescent material. The remaining amount marker 70 radiates (emits) visible rays for a predetermined time after being irradiated with the light emitted from the ultraviolet LED 26. The predetermined time is a time until excited molecules in the phosphorescent material return to a ground state. The characteristics of the remaining amount marker 70 will be described in detail below.

### Hardware Configuration of Receipt Printer

A hardware configuration of the receipt printer 20 will be described below with reference to FIG. 5. FIG. 5 is a hardware block diagram illustrating an example of the hardware configuration of the receipt printer 20.

As illustrated in FIG. 5, the receipt printer 20 includes a control unit 30 and a memory unit 34. The control unit 30 is a computer that controls the overall operation of the receipt printer 20 and realizes various functions of the receipt printer 20. The control unit 30 includes a CPU 31, a ROM 32, and a RAM 33. The CPU 31 comprehensively controls the operation of the receipt printer 20. The ROM 32 is a storage medium that stores various programs and data. The RAM 33 is a storage medium that temporarily stores various programs and rewrites various data. In order to realize various functions of the receipt printer 20, the CPU 31 executes a control program P2 stored in the memory unit 34 or the like with the RAM 33 as a work area. That is, the control unit 30 has a general computer configuration.

The memory unit 34 is a storage device such as an HDD (Hard Disk Drive) or an SSD (Solid State Drive). The memory unit 34 stores the control program P2 and the like. The control program P2 is a program for causing the functions of the receipt printer 20 to be implemented. The control program. P2 includes a program for realizing a characteristic function according to the embodiment.

The control unit 30 is connected to a controller 36 via an internal bus 35. Then, the controller 36 is connected with the thermal head 23 and the platen roller 24. Further, the controller 36 is connected with the ultraviolet LED 26 via an LED driver 25.

The LED driver 25 controls the turning on and off timing of the ultraviolet LED 26. The LED driver 25 is an example of a light amount adjusting unit.

Further, the controller 36 is connected to the POS terminal 10 via a USB interface 27 and the USB cable 50. Although not illustrated in FIG. 5, the controller 36 is further connected with a sensor (for example, a current-carrying sensor) configured to detect that the upper case 52 of the receipt printer 20 is in an opened state.

### Functional Configuration of Receipt Printer

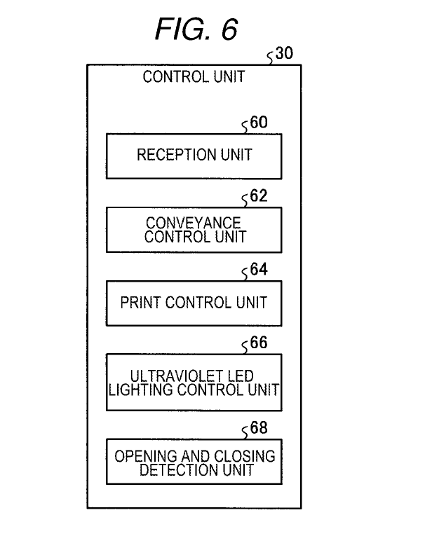

A characteristic functional configuration of the receipt printer 20 will be described below with reference to FIG. 6. FIG. 6 is a functional block diagram illustrating an example of the functional configuration of the receipt printer 20.

The control unit 30 of the receipt printer 20 loads the control program P2 stored in the memory unit 34 in the RAM 33 and operates according to the control program P2 to generate respective functional units illustrated in FIG. 6 on the RAM 33. Specifically, the control unit 30 realizes, as functional units, a reception unit 60, a conveyance control unit 62, a print control unit 64, an ultraviolet LED lighting control unit 66, and an opening and closing detection unit 68 by executing the control program P2.

The reception unit 60 receives print information from the POS terminal 10.

The conveyance control unit 62 controls a rotation of the platen roller 24 to convey the paper roll 40 toward the receipt issuing port 22 from the leading end 40b.

The print control unit 64 controls the thermal head 23 to print the print information on the paper roll 40.

The ultraviolet LED lighting control unit 66 controls the LED driver 25 to control the lighting state of the ultraviolet LED 26. Specifically, the ultraviolet LED lighting control unit 66 controls the light amount of the ultraviolet LED 26 to be irradiated such that an afterglow time of the phosphorescent material coated to the surface S of the paper roll 40 is within a predetermined time. Since the afterglow time of the phosphorescent material depends on the amount of the coated phosphorescent material, the spectral characteristics of the ultraviolet LED 26, and the light amount of the ultraviolet LED 26 to be irradiated, the drive conditions of the ultraviolet LED 26 are determined in advance by experiments.

The light amount of the ultraviolet LED 26 is controlled, for example, by a change of a voltage value applied to the ultraviolet LED 26. The voltage value is set such that the afterglow time of the phosphorescent material is within the predetermined time, based on the condition that an area of a length L (see FIG. 7) of the coating zone of the phosphorescent material moves within an irradiation range of the ultraviolet LED 26 at a conveyance speed (i.e., a rotation speed of the platen roller 24) of the paper roll 40. The afterglow time of the phosphorescent material is set to be within a time (for example, within several tens of seconds) until the discharged receipt 42 is handed over the customer. The determined drive condition of the ultraviolet LED 26 (for example, the voltage value to be applied to the ultraviolet LED 26) is stored in the memory unit 34 (see FIG. 5). Then, the ultraviolet LED lighting control unit 66 reads the drive condition of the ultraviolet LED 26 from the memory unit 34, and drives the ultraviolet LED 26 by controlling the LED driver 25.

In addition, the ultraviolet LED lighting control unit 66 controls to keep the amount of the light irradiated by the ultraviolet LED 26 constant. Generally, when the ultraviolet LED 26 is used for a long time, it gradually becomes darker due to age-based deterioration. At that time, since the current flowing through the ultraviolet LED 26 decreases, the ultraviolet LED lighting control unit 66 controls the LED driver 25 to control the current value so as to keep the current flowing through the ultraviolet LED 26 constant. Thus, the ultraviolet LED 26 constantly irradiates a constant amount of light.

The opening and closing detection unit 68 is a sensor that detects an opening and closing state of the upper case 52. Then, when the opening and closing detection unit 68 detects that the upper case 52 is opened, the ultraviolet LED lighting control unit 66 controls to stop the irradiation of the ultraviolet LED 26. Further, the conveyance control unit 62 controls to stop the rotation of the platen roller 24 when the opening and closing detection unit 68 detects that the upper case 52 is opened. Further, the print control unit 64 controls to stop the printing of the thermal head 23. Thus, it is possible to prevent an unexpected direct-viewing of the light emitting unit and contact of the body with the rotating portion and the high-temperature portion, and to reduce unnecessary power consumption when the upper case 52 is opened.

### Structure of Roll Paper

A structure of the paper roll 40 will be described below with reference to FIG. 7. FIG. 7 is a view illustrating an example of the structure of the paper roll 40 on which the remaining amount marker 70 is formed.

As illustrated in FIG. 7, the remaining amount marker 70 is printed on the surface S of the paper roll 40 pulled out from the leading end 40b and discharged from the receipt issuing port 22 (see FIG. 4). The remaining amount marker 70 indicates that the remaining amount of the paper roll 40 is equal to or lower than a predetermined amount. In the example of FIG. 7, the remaining amount marker 70 is formed by a solid line having a width W at a substantially central portion of the paper roll 40 on the portion of the paper roll 40 that is a predetermined length L from a finishing end 40a, which is an end on the winding center 44 (see FIG. 4) of the paper roll 40. The predetermined length L is a quantity corresponding to the remaining amount of the paper roll 40, and is set to a length that the cashier who notices the remaining amount marker 70 would consider as time for replacing the paper roll 40 with a new paper roll. Further, the width W is set to a size from which the light-emitting from the remaining amount marker 70 can be visually recognized by the cashier.

In the embodiment, the remaining amount marker 70 is formed by coating of ink containing the phosphorescent material. Since the ink containing the phosphorescent material exhibits, for example, milk-white and is almost the same color as that of the surface of the paper roll 40 on which the sales information is printed, it is difficult to visually recognize that the phosphorescent material is coated in a state where the phosphorescent material dose not emit light. The phosphorescent material is a substance having a property of emitting visible rays over a predetermined period of time even after irradiation with light including ultraviolet rays is stopped. For example, strontium aluminate (SrAl₂O₄) is a representative phosphorescent material. In order to improve the visibility of the remaining amount marker 70, luminescence color of the phosphorescent material is desirably colored red, for example. The remaining amount marker 70 may be formed by a plurality of layers including a layer that emits afterglow at the same wavelength as described above by receiving the light emitted by the ultraviolet LED 26 and a layer that has no phosphorescent property and emits visible rays by the light emitted from the afterglow emitting layer. In alternatively embodiments, an infrared LED may be provided in place of the ultraviolet LED 26, and the remaining amount marker 70 may emit afterglow in response to the light emitted by the infrared LED.

The remaining amount marker 70 may be formed, for example, by coating a medium containing a phosphorescent material onto the surface S of the paper roll 40. Alternatively, the remaining amount marker 70 may be formed by sticking a transparent sheet-like member containing a phosphorescent material onto the surface S of the paper roll 40.

When the phosphorescent material is irradiated with the ultraviolet rays, molecules in the phosphorescent material are excited. The phosphorescent material emits light when the excited molecules return to the ground state. That is, the greater the number of excited molecules, the longer the afterglow time. In order to excite a large number of molecules, the ultraviolet rays may be irradiated for a long time or the intensity of the ultraviolet rays to be irradiated may be increased. That is, the afterglow time can be controlled by the light irradiation time and the irradiation intensity. In the embodiment, the remaining amount marker 70 is irradiated with the light emitted by the ultraviolet LED 26. In place of the ultraviolet LED 26, an electric lamp emitting black light (such as ultraviolet rays) may be used.

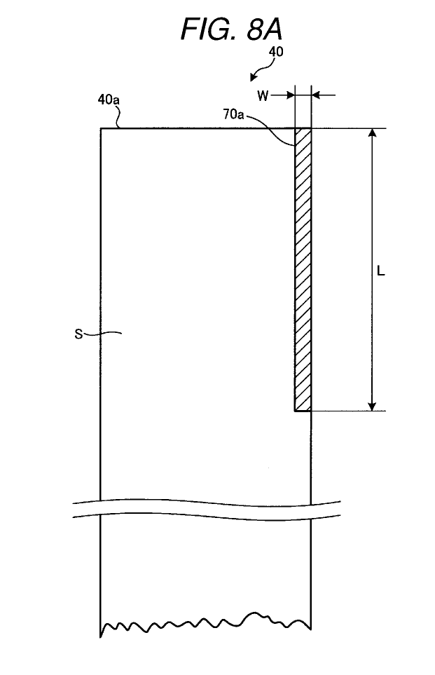

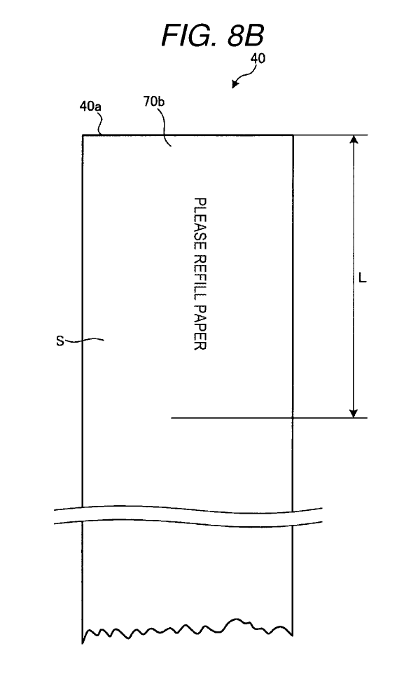

The form of the remaining amount marker 70 is not limited to the form illustrated in FIG. 7. FIGS. 8A and. 8B are diagrams illustrating other examples of the remaining amount marker 70. As illustrated in FIG. 8A, a remaining amount marker 70a may be formed in such a manner that the surface S of the paper roll 40 is coated with ink containing the phosphorescent material in a form of a solid line with the length L and the width W at an edge portion in the conveyance direction of the paper roll 40. When the remaining amount marker 70a is provided in such a form, since the print information printed on the paper roll 40 does not overlap with the remaining amount marker 70a that emits light, the cashier can reliably confirm the remaining amount marker 70a and confirm the fact that the print information is printed.

Further, as illustrated in FIG. 8B, a remaining amount marker 70b may be formed in such a manner that the surface S of the paper roll 40 is coated with character information such as “Please refill paper” over the length L using ink containing a phosphorescent material. In this manner, when the remaining amount marker 70b is formed by the character information, an inexperienced cashier can also reliably recognize that refilling of the paper roll 40 is necessary.

The cashier visually recognizes that the remaining amount marker 70 is glowing on the surface S of the receipt 42 discharged from the receipt printer 20. Thus, the cashier recognizes that the remaining amount of the paper roll 40 is low. Then, the cashier prepares a new paper roll to replace the paper roll 40 in the receipt printer 20 after the customer's payment is completed. Since the afterglow time of the remaining amount marker 70 is within the predetermined time, when the discharged receipt 42 is handed over the customer, the remaining amount marker 70 does not emit light, and the customer does not visually recognize the remaining amount marker 70.

### Processing Flow of Receipt Printer

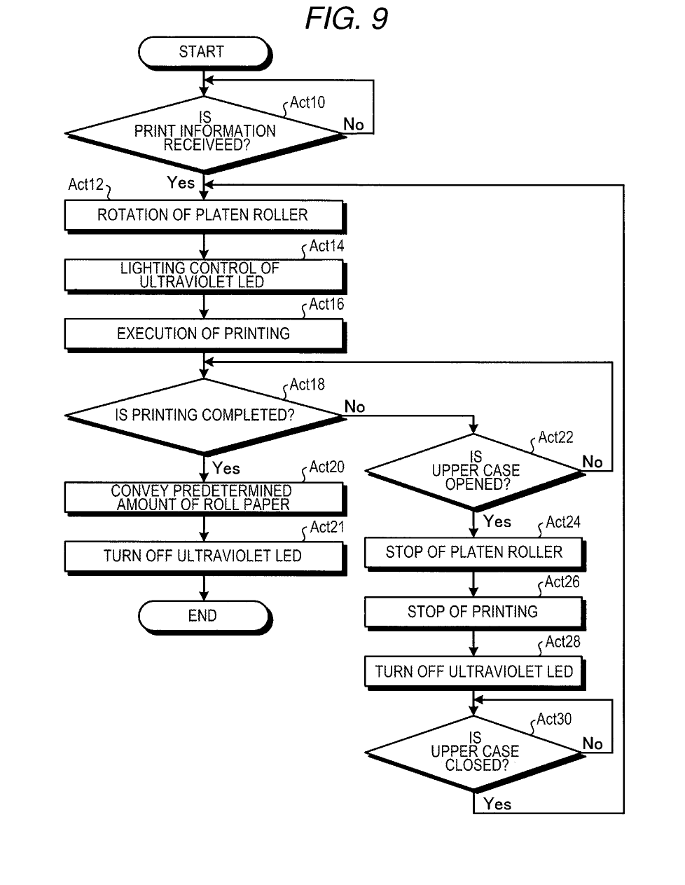

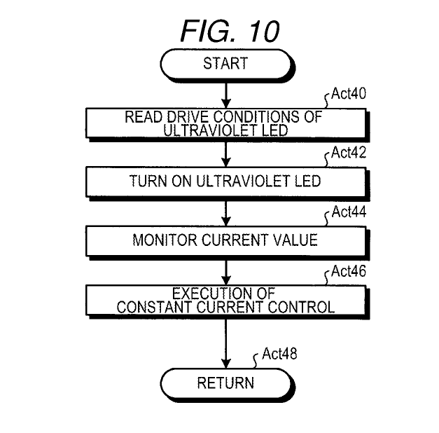

A processing flow of the receipt printer 20 will be described below with reference to FIGS. 9 and 10. FIG. 9 is a flowchart illustrating an example of a processing flow when the receipt printer 20 prints and issues the receipt 42. FIG. 10 is a flowchart illustrating an example of a flow of lighting control of the ultraviolet LED 26.

First, the flowchart illustrated in FIG. 9 will be described. The reception unit 60 determines whether print information is received from the POS terminal 10 (Act 10). If the reception unit 60 determines that the print information is received (Act 10: Yes), the process proceeds to Act 12. If the reception unit 60 determines that the print information is not received (Act 10: No), Act 10 is repeated until the timeout.

In subsequent Act 12, the conveyance control unit 62 rotates the platen roller 24. Thus, a portion of the paper roll 40 which is drawn out is conveyed in the conveyance direction P (see FIG. 4).

Next, the ultraviolet LED lighting control unit 66 performs the lighting control of the ultraviolet LED 26 (Act 14). The lighting control of the ultraviolet LED 26 will be described in detail below.

Next, the print control unit 64 executes printing on the paper roll 40 (Act 16).

Further, the print control unit 64 determines whether the printing is completed (Act 18). When the print control unit 64 determines that the printing is completed (Act 18: Yes), the process proceeds to Act 20. On the other hand, when the print control unit 64 determines that the printing has not yet completed (Act 18: No), the process proceeds to Act 22.

In Act 20, the conveyance control unit 62 conveys the printed paper roll 40 toward the receipt issuing port 22 by a predetermined amount. The predetermined amount of the paper roll 40 to be conveyed is, for example, an amount in a state in which when the paper roll 40 discharged from the receipt issuing port 22 is cut out by the cutter 28, the print information is displayed completely, without missing any information, on the cut receipt 42. Here, although not illustrated in the flowchart of FIG. 9, after the paper roll 40 is conveyed by the predetermined amount in Act 20, the conveyance control unit 62 may cut the paper roll 40 by controlling movement of the cutter 28. Following Act 20, the ultraviolet LED is turned off (Act 21), and the receipt printer 20 ends the series of processing in FIG. 9.

When the print control unit 64 determines in Act 18 that the printing has not yet completed (Act 18: No), the opening and closing detection unit 68 determines whether the upper case 52 of the receipt printer 20 is opened (Act 22). When the opening and closing detection unit 68 determines that the upper case 52 is opened (Act 22: Yes), the process proceeds to Act 24. On the other hand, the opening and closing detection unit 68 determines that the upper case 52 is not opened (Act 22: No), the process returns to Act 18.

In Act 24 subsequent to Yes in Act 22, the conveyance control unit 62 stops the rotation of the platen roller 24.

In Act 26, the print control unit 64 causes the thermal head 23 to stop printing.

In Act 28, the ultraviolet LED lighting control unit 66 turns off the ultraviolet LED 26.

Subsequently, the opening and closing detection unit 68 determines whether the upper case 52 of the receipt printer 20 is closed (Act 30). When the opening and closing detection unit 68 determines that the upper case 52 is closed (Act 30: Yes), the process returns to Act 12. On the other hand, when the opening and closing detection unit 68 determines that the upper case 52 is not closed (Act 30: No), the determination in Act 30 is repeated.

Next, the flow of lighting control of the ultraviolet LED 26 performed by the ultraviolet LED lighting control unit 66 will be described with reference to a flowchart of FIG. 10. As illustrated in FIG. 10, first, the ultraviolet LED lighting control unit 66 reads drive conditions of the ultraviolet LED 26 from the memory unit 34 (Act 40).

Subsequently, the ultraviolet LED lighting control unit 66 turns on the ultraviolet LED 26 based on the drive conditions read from the memory unit 34 (Act 42).

Further, the ultraviolet LED lighting control unit 66 monitors a current value flowing through the ultraviolet LED 26 by measuring a current value flowing through the LED driver 25 (Act 44).

Then, the ultraviolet LED lighting control unit 66 performs constant current control to control the current value flowing through the LED driver 25 so as to keep the current flowing through the ultraviolet LED 26 constant (Act 46). Thereafter, the process returns to Act 16 in FIG. 9 (Act 48). The constant current control in Act 46 is continuously executed until the ultraviolet LED 26 is turned off.

### Modified Example of First Embodiment

In the first embodiment, the remaining amount markers 70, 70a, and 70b are described. These remaining amount markers 70, 70a, and 70b are markers indicating that the remaining amount of the paper roll 40 is low, but are not markers indicating how much the remaining amount exist. In contrast, a remaining amount marker may be formed indicating how much the remaining amount of the paper roll 40 exists.

FIG. 11 is a diagram illustrating an example of a remaining amount marker 70c indicating the remaining amount of the paper roll 40. The remaining amount marker 70c is coated onto a predetermined area (length L and width W) on a finishing end 40a of the paper roll 40 in the same form as the remaining amount marker 70 (see FIG. 7). Then, as illustrated in FIG. 11, the amount of a phosphorescent material coated onto the remaining amount marker 70c is increased as the position approaches the finishing end 40a. That is, the remaining amount marker 70c includes only the amount of phosphorescent material p1 at the end of the finishing end 40a. Then, the remaining amount marker 70c includes only the amount of phosphorescent material p0 (p1>p0) at the end of a leading end 40b. The amount of the phosphorescent material is, for example, a density of the phosphorescent material containing ink. That is, the remaining amount marker 70c is formed in such a manner that high-density ink is coated as the position approaches the finishing end 40a of the paper roll 40.

When the remaining amount marker 70c formed in this manner is irradiated with the ultraviolet LED 26 for the same time, since more molecules are excited as the position approaches the finishing end 40a of the paper roll 40, the remaining amount marker 70c emits brighter light. Therefore, the cashier can recognize how much the remaining amount of the roller paper 40 exists due to the brightness of afterglow emitted from the phosphorescent material.

As described above, the paper roll 40 of the first embodiment in which long paper is wound in the form of a roll includes the remaining amount marker 70 formed of a medium containing the phosphorescent material in the area from the finishing end 40a of the paper roll 40 to the position of the predetermined length L from the finishing end 40a. Therefore, it is possible to provide the paper roll 40 capable of notifying the cashier who prints the receipt that the remaining amount of the paper roll 40 is low.

Further, according to the modified example of the first embodiment, the remaining amount marker 70 of the paper roll 40 is formed of phosphorescent materials having different densities according to the distance from the finishing end 40a of the paper roll 40. Therefore, the approximate remaining amount of the paper roll 40 can be recognized due to the brightness of the afterglow emitted from the phosphorescent material. Thus, new paper roll 40 can be prepared before the paper roll 40 completely disappears.

In addition, according to the receipt printer 20 of the first embodiment, while the platen roller 24 conveys the leading end 40b of the paper roll 40 from the upstream side to the downstream side, the thermal head 23 prints on the paper roll 40 conveyed by the platen roller 24. Then, the ultraviolet LED 26 irradiates the remaining amount marker 70, which is formed of the ink containing the phosphorescent material and indicates that the remaining amount of the paper roll 40 is equal to or less than the predetermined amount, with the light, and the paper is discharged as the receipt 42 from the receipt issuing port 22. Therefore, it is possible to reliably notify the cashier who prints the receipt 42 that the remaining amount of the paper roll 40 is low.

According to the receipt printer 20 of the first embodiment, the ultraviolet LED 26 adjusts the amount of light irradiating the remaining amount marker 70 such that the afterglow time of the phosphorescent material is within the predetermined time. Therefore, only immediately after the receipt printed by the receipt printer 20 is discharged from the receipt printer 20, the remaining amount marker 70 emits the afterglow. For this reason, only the cashier who operates the receipt printer 20 can visually recognize the remaining amount marker 70 of the paper roll 40.

Further, according to the receipt printer 20 of the first embodiment, the receipt issuing port 22 discharges the paper roll 40 such that the formation surface of the remaining amount marker 70 faces the cashier who operates the receipt printer 20. Therefore, the cashier can visually recognize the remaining amount marker 70 of the paper roll 40 without taking a special posture with respect to the paper roll 40.

In addition, according to the receipt printer 20 of the first embodiment, the ultraviolet LED 26 further includes the LED driver 25 configured to keep the amount of light to be irradiated constant by keeping the current flowing through the ultraviolet LED 26 constant. Therefore, even when the ultraviolet LED 26 is deteriorated, the remaining amount marker 70 can reliably emit light for a predetermined time.

### Second Embodiment

A payment apparatus according to a second embodiment will be described below. A payment apparatus 2a (not illustrated) according to the second embodiment includes the POS terminal 10 described in the first embodiment and a receipt printer 20a. The payment apparatus 2a notifies the POS terminal 10 of the detection result when the receipt printer 20a detects that the remaining amount of the paper roll 40 is equal to or less than a predetermined amount.

### Hardware Configuration of Receipt Printer

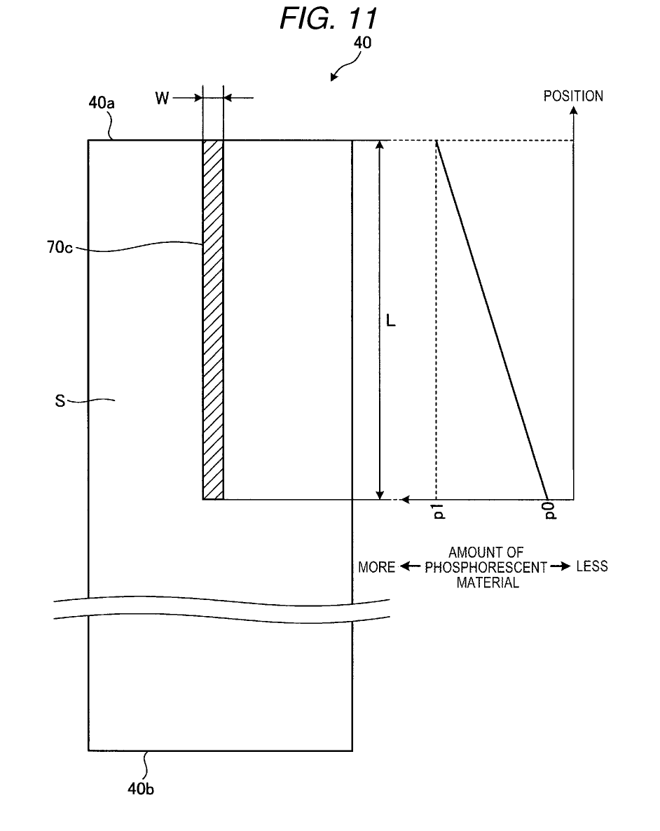

A hardware configuration of the receipt printer 20a which is a component of the payment apparatus 2a will now be described with reference to FIG. 12. FIG. 12 is a hardware block diagram illustrating an example of a hardware configuration of the receipt printer 20a.

As illustrated in FIG. 12, the receipt printer 20a includes a control unit 30a and a memory unit 34a. The control unit 30a is a computer that controls the overall operation of the receipt printer 20a and realizes various functions of the receipt printer 20a. The control unit 30a includes a CPU 31, a ROM 32, and a RAM 33. The CPU 31 comprehensively controls the operation of the receipt printer 20a. The ROM 32 is a storage medium that stores various programs and data. The RAM 33 is a storage medium that temporarily stores various programs and rewrites various data. Further, the CPU 31 executes a control program P3 stored in the memory unit 34a using the RAM 33 as a work area. That is, the control unit 30a has a general configuration of a computer.

The memory unit 34a is a storage device such as an HDD (Hard Disk Drive), an SSD (Solid State Drive), and the like. The memory unit 34a stores the control program P3, and the like. The control program P3 is a program for causing the functions of the receipt printer 20a to be implemented. The control program P3 includes a program for realizing a characteristic function according to the embodiment.

The control unit 30a is connected to a controller 36a via an internal bus 35. A thermal head 23 and a platen roller are connected to the controller 36a. Further, the controller 36a is connected with an LED 26a via an LED driver 25, and is connected with a light receiving sensor 29.

The LED 26a is an LED for emitting light of a specific wavelength, and is an example of light irradiation unit. Further, while the ultraviolet LED 26 is used in the first embodiment, the LED 26a used in the second embodiment is not limited to an LED for emitting ultraviolet rays, and may be an LED for emitting visible light. Further, the light receiving sensor 29 is a sensor configured to detect an amount of reflected light generated when light emitted by the LED 26a is reflected on the surface S of the paper roll 40. For example, the light receiving sensor 29 includes photodiodes.

Further, the controller 36a is connected to the POS terminal 10 via the USB interface 27. Additionally, although not illustrated in FIG. 12, the controller 36a is connected with a sensor (for example, a current-carrying sensor) configured to detect that the upper case 52 of the receipt printer 20a is in an opened state.

### Functional Configuration of Receipt Printer

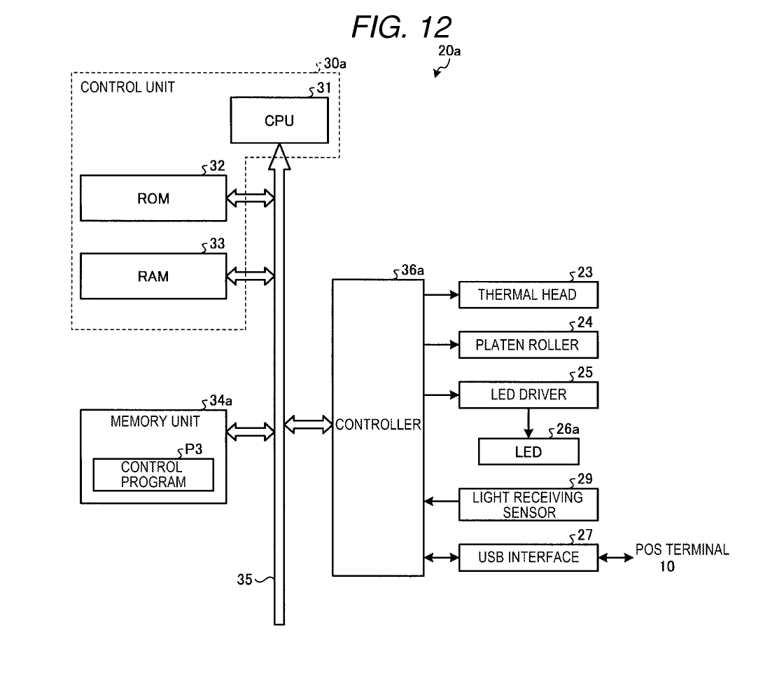

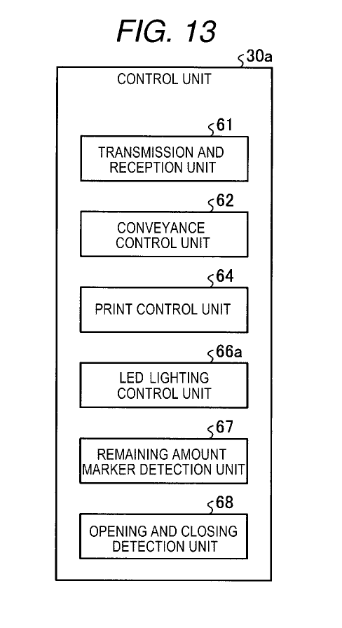

A characteristic functional configuration of the receipt printer 20a will be described below with reference to FIG. 13. FIG. 13 is a functional block diagram illustrating an example of the functional configuration of the receipt printer 20a.

The control unit 30a of the receipt printer 20a loads the control program P3 stored in the memory unit 34a in the RAM 33, and operates according to the control program P3 to generate respective function units illustrated in FIG. 13 in the RAM 33. Specifically, the control unit 30a realizes a transmission and reception unit 61, the conveyance control unit 62, the print control unit 64, an LED lighting control unit 66a, a remaining amount marker detection unit 67, and the opening and closing detection unit 68 as functional units by executing the control program P3.

The transmission and reception unit 61 receives print information from the POS terminal 10. Further, the transmission and reception unit 61 transmits a state where the remaining amount of the paper roll 40 is equal to or less than a predetermined amount to the POS terminal 10.

The LED lighting control unit 66a controls a lighting state of the LED 26a. Specifically, the LED lighting control unit 66a controls the turning on and off of the LED 26a.

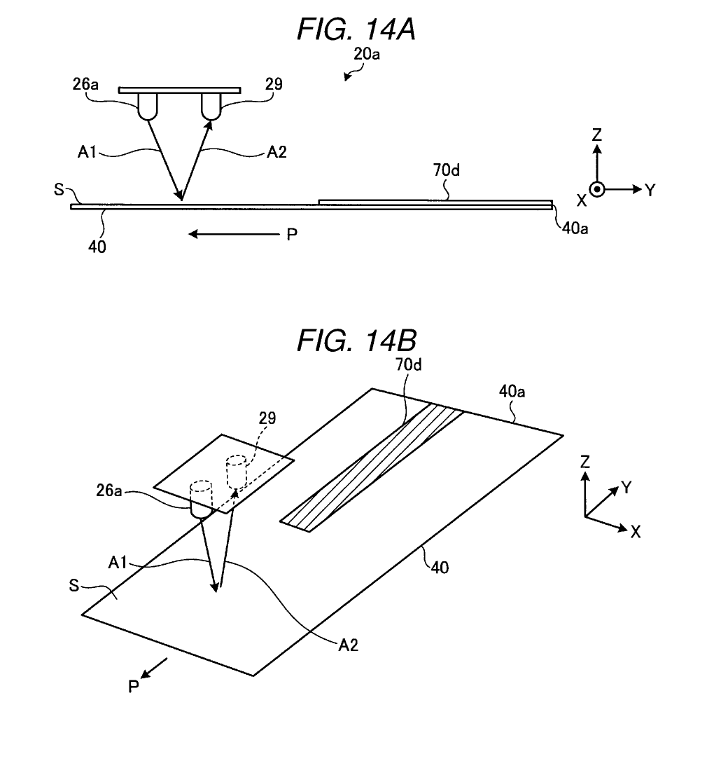

The remaining amount marker detection unit 67 detects a remaining amount marker 70d (see FIGS. 14A and 14B) formed on the surface S of the paper roll 40. Specifically, the remaining amount marker detection unit 67 detects the remaining amount marker 70d based upon the quantity of the light reflected on the surface S of the paper roll 40 detected by the light receiving sensor 29.

Further, respective functions of the conveyance control unit 62, the print control unit 64, the opening and closing detection unit 68 are the same as what is described in the first embodiment.

Method of Detecting Remaining amount of Roll Paper

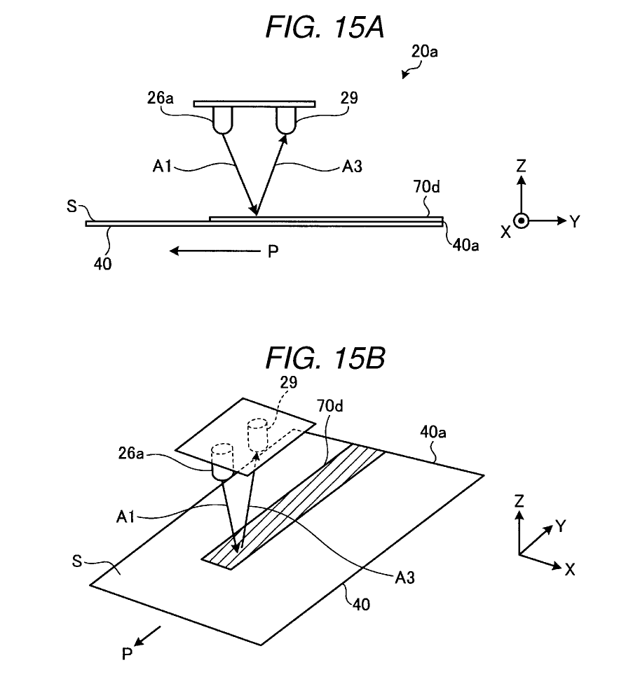

Next, a method of detecting a remaining amount of the paper roll 40 will now be described with reference to FIGS. 14A and 14B, and FIGS. 15A and 15B. FIGS. 14A and 14B are first diagrams illustrating a method of detecting the remaining amount marker 70d by the receipt printer 20a, and illustrate a state where the remaining amount marker 70d is not detected. FIGS. 15A and 15B are second diagrams illustrating a method of detecting the remaining amount marker 70d by the receipt printer 20a, and illustrate a state where the remaining amount marker 70d is detected.

FIG. 14A is a Y-Z sectional view of the receipt printer 20a along a conveyance direction P of the paper roll 40. Further, FIG. 14B is a perspective view of FIG. 14A. As illustrated in FIGS. 14A and 14B, an irradiated light A1 of the LED 26a is irradiated on the surface S of the paper roll 40 after printing from a positive side of the Z axis. The irradiated light A1 is reflected on the surface S of the paper roll 40, and a reflected light A2 reaches the light receiving sensor 29.

Further, the remaining amount marker 70d indicating the state where the remaining amount of the paper roll 40 is equal to or less than a predetermined amount is formed on the surface S of the paper roll 40. For example, when light of a first wavelength is irradiated, the remaining amount marker 70d is characterized to reflect light of a second wavelength. Further, the first wavelength and the second wavelength may be the same wavelength or may not be the same wavelength.

The light receiving sensor 29 is a sensor by which a large output signal is output when receiving the light of the second wavelength.

Specifically, the remaining amount marker 70d uses the transparent sheet by which near-infrared light is selectively reflected; retroreflective coating by which incident light is retroreflected in an incident direction; and fluorescent coating which emits light by receiving black light. The LED 26a emits light of a wavelength at which the remaining amount marker 70d has high reflectivity. Further, the remaining amount marker 70d is not required to be provided with afterglow properties in comparison with the remaining amount markers 70, 70a, 70b, and 70c, all of which are described in the first embodiment. At least, when the light emitted from. the LED 26a is irradiated, the reflected light of the wavelength according to the irradiated light may be generated.

In the case of FIGS. 14A and 14B, the irradiated light A1 of the LED 26a is irradiated on a region where the remaining amount marker 70d is not formed, among the surfaces S of the paper roll 40. Accordingly, intensity of the reflected light A2 that reaches the light receiving sensor 29 is lower than a threshold value set in advance.

Meanwhile, in the case of FIGS. 15A and 15B, the irradiated light A1 of the LED 26a is irradiated on a region where the remaining amount marker 70d is formed, among the surfaces S of the paper roll 40. Accordingly, intensity of the reflected light A3 that reaches the light receiving sensor 29 is greater than the threshold value set in advance.

When the intensity of the reflected light A3 that reaches the light receiving sensor 29 is greater than the threshold value set in advance, the transmission and reception unit 61 (see FIG. 13) transmits information indicating that the remaining amount of the paper roll 40 is low to the POS terminal 10.

When receiving the information indicating that the remaining amount of the paper roll 40 is low from the transmission and reception unit 61, the POS terminal 10 displays a state where the remaining amount of the paper roll 40 is low on the display unit 12. When recognizing the above-mentioned information, the cashier prepares a new n paper roll to replace the paper roll 40 when payment process is completed.

Further, when the cashier recognizes that the remaining amount marker 70d of the paper roll 40 is shining by setting the reflected light A3 to be the visible light, the cashier may also recognize that the remaining amount of the paper roll 40 is low. Specifically, for example, an observation window (not illustrated) is formed in a vicinity of the receipt issuing port on the upper case 52 of the receipt printer 20a, such that the cashier may visually confirm the reflected light A3 through the observation window from an external part of the receipt printer 20a.

Processing flow of Receipt Pinter

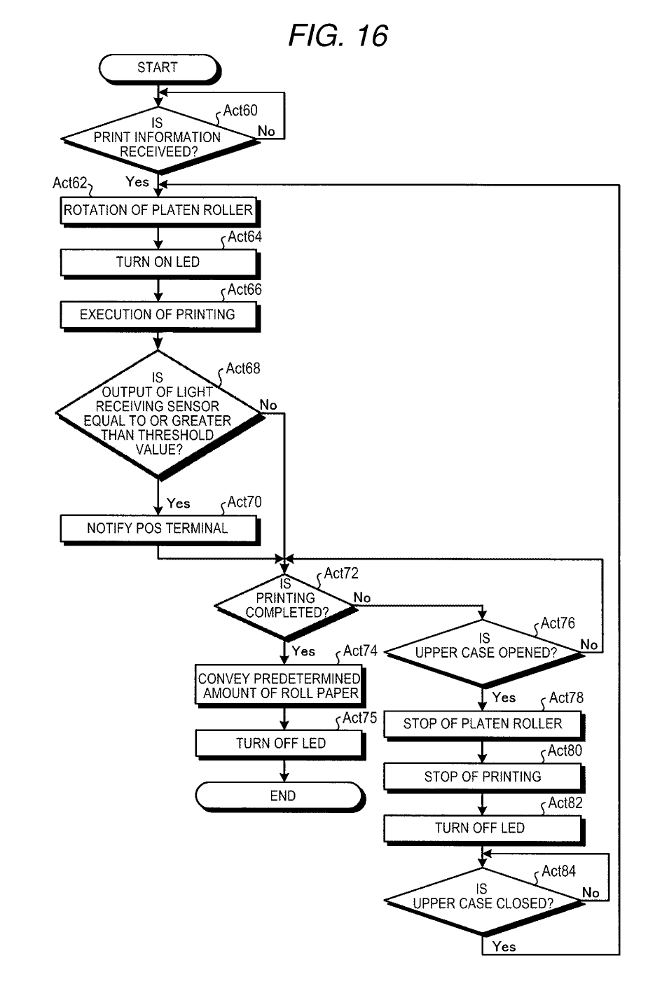

Next, a processing flow of the receipt printer 20a will now be described with reference to FIG. 16. FIG. 16 is a flowchart illustrating an example of a processing flow performed by the receipt printer 20a when the receipt 42 is printed and then issued.

The transmission and reception unit 61 determines whether the print information is received from the POS terminal (Act 60). When the transmission and reception unit 61 determines that the print information is received (Act 60: Yes), the conveyance control unit 62 rotates the platen roller 24 (Act 62). Meanwhile, when the transmission and reception unit 61 determines that the print information is not received (Act 60: No), Act 60 is repeated.

Following Act 62, the LED lighting control unit 66a turns on the LED 26a (Act 64). Next, the print control unit 64 prints on the paper roll 40 (Act 66).

The remaining amount marker detection unit 67 determines whether an output of the light receiving sensor 29 is greater than the threshold value (Act 68). When the output of the light receiving sensor 29 is determined to be greater than the threshold value (Act 68: Yes), the process proceeds to Act 70, and notifies the POS terminal 10 that the remaining amount of the paper roll 40 is low, and then the process proceeds to Act 72.

Meanwhile, when the remaining amount marker detection unit 67 determines that the output of the light receiving sensor 29 is not greater than the threshold value (Act 68: No), the process proceeds to Act 72.

Since a flow subsequent to Act 72 is the same as the processing flow subsequent to Act 18 described in FIG. 9, the description thereof will be omitted.

While some embodiments of the present invention have been described, these embodiments are merely examples, and are not intended to limit the scope of the invention. These novel embodiments may be implemented in various other forms, and various omissions, replacements, and modifications maybe made without departing from the scope and spirit of the invention. These embodiments and the modifications are included in the scope and spirit of the invention, and are included in the invention described in the claims and their equivalents.

For example, according to the exemplary embodiments described above, after the thermal head 23 performs the printing, the ultraviolet LED 26 and the LED 26a irradiate the light on the paper roll 40. Alternatively, the ultraviolet LED 26 and the LED 26a may be provided at the upstream side (the positive side of the Y axis in FIG. 4) higher than the thermal head 23, and light irradiation maybe performed before the thermal head 23 performs the printing.

Further, the control unit 30 (see FIG. 5) provided in the receipt printer 20 may be incorporated into the control unit 3 of the payment apparatus 2 (see FIG. 2).

Further, in the first embodiment, the residual light emitted from the remaining amount marker 70 may be detected by the light receiving sensor, and when a detected quantity of the reflected light is greater than the predetermined value, notification thereabout may be performed.

What is claimed is:

1. A paper roll in which a paper strip is wound in a form of a roll, the paper roll including a marker formed of a medium containing a phosphorescent material on an end portion of the paper strip that extends from a finishing end of the paper roll to a position this is a predetermined length from the finishing end.

2. The paper roll according to claim 1, wherein the marker becomes visible as a result of irradiating the phosphorescent material with ultraviolet rays.

3. The paper roll according to claim 2, wherein the visible color of the marker is red.

4. The paper roll according to claim 3, wherein the marker, when visible, displays characters in red.

5. The paper roll according to claim 1, wherein the marker has a constant width along the end portion of the paper strip and is centered with respect to lateral sides of the paper strip.

6. The paper roll according to claim 1, wherein the marker is formed of phosphorescent materials having densities that vary according to a distance from the end of the paper strip.

7. The paper roll according to claim 6, wherein the marker has a higher density of phosphorescent materials at a first portion than at a second portion, which is farther from the end of the paper strip than the first portion.

8. A printer comprising:
a roller configured to convey paper supplied from a paper roll;
a printing head configured to print information on the paper conveyed by the roller;
one or more ultraviolet light emitting diodes (LEDs) positioned downstream of the printing head in a conveyance direction of the paper; and
a control unit configured to turn on the LEDs to irradiate the paper on which the information has been printed and discharged out of the printer.

9. The printer according to claim 8, wherein
an amount of ultraviolet rays irradiated onto the paper is adjustable by the control unit.

10. The printer according to claim 9, wherein a surface of the paper that is irradiated faces an operator of the printer when the paper is discharged.

11. The printer according to claim 10, wherein a surface of the paper on which the information is printed is the same surface as the surface of the paper that is irradiated.

12. The printer according to claim 8, wherein
the control unit is configured to adjust a current flowing through the LEDs to keep an amount of light irradiated onto the paper constant.

13. The printer according to claim 8, wherein the paper roll includes a marker formed of a medium containing a phosphorescent material on an end portion of the paper strip that extends from a finishing end of the paper roll to a position this is a predetermined length from the finishing end.

14. The printer according to claim 13, wherein the marker becomes visible as a result of irradiating the phosphorescent material with light of a predetermined wavelength range.

15. The printer according to claim 13, wherein the marker has a constant width along the end portion of the paper strip and is centered with respect to lateral sides of the paper strip.

16. The printer according to claim 13, wherein the marker is formed of phosphorescent materials having densities that vary according to a distance from the end of the paper strip.

17. The printer according to claim 16, wherein the marker has a higher density of phosphorescent materials at a first portion than at a second portion, which is farther from the end of the paper strip than the first portion.

18. A printer comprising:
a roller configured to convey paper supplied from a paper roll;
a printing head configured to print information on the paper conveyed by the roller;
alight source positioned downstream of the printing head in a conveyance direction of the paper;
a light detector positioned to detect light reflected from the paper when light from the light source is irradiated onto the paper; and
a control unit configured to turn on the light source to irradiate the paper on which the information has been printed and discharged out of the printer, and issue a low paper notification when an intensity of the detected light is above a threshold.

19. The printer according to claim 18, wherein the light source irradiates light of a first wavelength and the reflected light is of a second wavelength.

20. The printer according to claim 19, wherein the first wavelength and the second wavelength are different wavelengths, and the reflected light is visible.
